(19) United States
(12) Patent Application Publication
(10) Pub. No.: US 2006/0145435 A1
(43) Pub. Date: Jul. 6, 2006

(54) Snowboard binding

(75) Inventor: Helmut Holzer, St. Johann (AT)

Correspondence Address: COLLARD & ROE, P.C., 1077 Northern Boulevard, Roslyn, NY, 11576, US

(73) Assignee: ATOMIC Austria GmbH

(21) Appl. No.: 11/323,868

(22) Filed: Dec. 30, 2005

(30) Foreign Application Priority Data
Dec. 30, 2004 (AT) A 2196/2004

(51) Int. Cl. B62B 15/00

(52) U.S. Cl. 280/14.24

(57) ABSTRACT

The invention relates to a snowboard binding (1) with a stable base plate (3) made of solid or rigid materials. Said base plate (3) is provided to be mounted on a snow-board (3) and has a stand-on plane (4) on its top side for supporting the sole of a snow-boarding boot. Furthermore, the snowboard binding (1) comprises a calf support (5) aligned substantially perpendicularly to the stand-on plane (4) of the base plate (3) for supporting the back part of the lower leg of the snowboarder. In addition, at least one coupling element (11, 12) is formed for detachably—if need be—connecting the snowboarding boot with the base plate (3). Said base plate (3) is formed by at least two base plate components (14, 15), whereby the front and rear base plate components each form a support for supporting the front and rear sections of the sole of the snowboarding boot, and whereby the alignment and/or orientation between the front base plate component (14) and the rear base plate component (15) can be changed and fixed by the snowboarder as needed. The calf support (5) is mounted on the rear base plate component (15).

### CROSS REFERENCE TO RELATED APPLICATIONS

Applicant claims priority under 35 U.S.C. § 119 of AUSTRIAN Patent Application No. A 2196/2004 filed on Dec. 30, 2004.

### BACKGROUND OF THE INVENTION

1. Field of the Invention

The invention relates to a snowboard binding comprising a stable base plate made of solid or rigid materials. Such a base plate is provided for being mounted on a snowboard. Its top side is formed to serve as a stand-on plane for supporting the sole of a snowboarding boot, with a calf support substantially aligned perpendicularly to the stand-on plane of the base plate for supporting the back of the lower leg of the snowboarder. Furthermore, it comprises at least one coupling element for connecting the snowboarding boot—detachably, if necessary—with the base plate.

2. The Prior Art

Numerous snowboard bindings are known that comprise a base plate, via which such a binding system can be mounted on a snowboard. The shape and size of such a base plate approximately conforms to the sole of a boot intended for snowboarding. As a rule, the base plate is dimensioned slightly shorter than the length of the sole of the snowboarding boot, which can be fixed and detached by means of the snowboard binding as required. Furthermore, it is known to form extensions in the longitudinal marginal areas of the base plate, such extensions protruding upwards perpendicularly to the stand-on plane of the base plate. Said extensions, which are relevant to the rigidity of the base plate, are molded onto the latter, preferably forming one single piece with the base plate, and, furthermore, may sere as mounting extensions for holding a support bracket in the shape of a “U”, viewed from the top. Such a U-shaped support bracket is intended for surrounding the heel part of the snowboarding boot, whereby such a U-shaped support bracket can be supported in such a way that it is individually adjustable and fixable vis-à-vis the base plate in the longitudinal direction of the binding for adapting it to different boot sizes. For said purpose, provision is made for a number of breakthroughs or oblong holes in the edge-side extensions of the base plate, or in the two legs of the support bracket, such passages or holes being spaced from each other and intended for receiving fastening screws, as it is shown, for example in EP 1 127 592 A1. Furthermore, the known snowboard bindings comprise a so-called calf support, via which the user of the snowboard binding is supported in the rearward direction. Such a calf support may be supported directly on the extensions, and can be swiveled to an extent limited by stop means around a pivotal axis extending transversely to the longitudinal axis of the binding. Alternatively, such a rotational support can be formed directly on the U-shaped support bracket. The limitation for stopping the calf support in the rearward direction is preferably effected by a stop element on the calf support. Such snowboard bindings are usually equipped with belt arrangements and/or automatic coupling devices for forming so-called “step-in” bindings. Such known binding systems have the drawback that their adaptation to the individual requirements of the snowboard rider is possible only to a relatively limited extent.

### SUMMARY OF THE INVENTION

The present invention is based on the problem of providing a snowboard binding that permits superior adaptation to the individual preferences, as well as superior adaptation to the physical conditions of different snowboarders.

Said problem of the invention is resolved by a snowboard binding in connection with which the base plate is formed by at least two base plate components, whereby the front and the rear base plate components each form a support for the front and rear parts of the snowboarding boot, and the alignment and/or orientation between the front and rear base plate components can be changed and fixed by the snowboarder as needed, with the calf support being mounted on the hear base plate component.

One of the advantages of the snowboard binding as defined by the invention lies in that its base plate can be individually adapted in the best possible way to the preferences and conditions of the user. In particular, it is possible in a simple manner to adapt the base plate of the snowboard binding to the given boot size or length of the sole and/or shape of the snowboarding boot. Owing to such adaptability of the base plate to the size or length, it is possible to increase or optimize the comfort of the snowboarder, on the one hand, and to upgrade the performance achievable with such a snowboard binding on the other. In addition to such benefits for the user of the snowboard binding, various positive effects are gained for a dealer or lessor of such a snowboard binding as well. In particular, the variety of sizes or types of snowboard bindings that have to be offered to all kinds of different persons interested in snowboarding can be reduced because the snowboard binding as defined by the invention can be adapted to different preferences and many conditions of use in a simple manner. But positive effects benefit also the manufacturer of the snowboard binding as defined by the invention equipped with the special base plate. In particular, by producing just one base plate it is nonetheless possible to offer a certain variety of different types of snowboard bindings, so that the production costs are reduced. Especially the number of cost-intensive injection molds required for their production can be kept low. An important benefit can be seen also in that the snowboard binding or its base plate as defined by the invention can be easily adapted in a simple way to left-side or right-side use. It is particularly possible with only one design of the base plate to at least approximately adapt two structurally identical snowboard bindings to the shape of the sole of the left and the shape of the sole of the right snowboarding boot. Furthermore, in a surprising and unforeseeable manner, the snowboard binding as defined by the invention permits enhanced control or steering of a snowboard as well. It is particularly possible by means of the snowboard binding as defined by the invention to raise the individual steerability or rate of reaction of a snowboard if the base plate and the calf support are optimally adapted to the individual snowboarder. This is achieved primarily if the calf support can be set to the position of optimal transmission of force from the leg of the user and the snowboard. In particular, the controlling forces exerted by the user can be transmitted to the snowboard in a superior manner because the calf support, which is supposed to further transmit the controlling forces exerted by the foot of the user, taking into account the given position of the leg, can be adjusted as optimally as possible. Twisted positions interfering with the locking of force between the calf support and the calf or leg of the snwoboarder can be avoided in a simple way with the snowboard binding as defined by the invention. In particular, owing to the theoretically relatively extensive swiveling range of the calf support within a relatively large range of the angle of rotation, what is achievable without problems is that the calf or the snowboarding boot will act on the supporting surface of the calf support over as large a surface area as possible. Therefore, the snowboard binding as defined by the invention permits in a simple way easy adjustability of the calf support with respect to its angular position around an axis extending about vertically in relation to the base plate, as well as also adaptation of the base plate to different sizes and shapes of snowboarding boots.

Advantageous is also a further development of the snowboard binding, where a rotational support is provided between the front and rear base plate components, said support forming a pivotal axis aligned substantially perpendicularly to the stand-on plane, because such a design provides a one-piece, multi-component base plate that can be easily mounted on a snowboard in a simple manner. In addition, such a rotational support, which couples the two base plate components with each other, provides a usefully limited relative adjustment between the front base plate component and the rear base plate component.

An embodiment of the snowboard binding, where the pivotal axis of the rotational support can be positioned and fixed within the stand-on plane with limited variability, is advantageous as well because the curvature and longitudinal expanse of the base plate comprised of the two base plate components can be individually changed in this way, or adapted to the given requirements in the best possible way.

A particularly simple and quick change of the adjustments is made possible owing to the fact that a single central adjusting and locking device is formed for the rotational support.

An embodiment of the snowboard binding, where the front and rear base plate components overlap one another in their end sections facing each other, is beneficial as well because a base plate having as much stability and dimensional rigidity as possible is obtained in this way.

With the embodiment of the snowboard binding, where the rear base plate component is supported on the front base plate component in a manner transmitting the load, the relative adjustability of the rear base plate component versus the front base plate component remains independent of the surface condition of a snowboard, so that the intended adjustability of the rear base plate component is always assured.

The embodiment of the snowboard, where a circular suppressing disk is formed that bridges both the front and the rear base plate components, is advantageous in that its permits endless or unlimited pivoting of the base plate around the circular suppressing disk

The further development of the snowboard binding, where the suppressing disk positively connects the front base plate component with the rear base plate component, forming the rotational support, offers the advantage that a defined relative position is maintained between the two base plate components, because the front base plate component and the rear base plate component are kept positioned via the suppressing disk in the vertical direction relative to the pivotal axis of the rotational support.

An embodiment of the snowboard binding, where at least one oblong breakthrough for a fastening means is formed in the suppressing disk for mounting it on a snowboard in variable positions, is advantageous as well because the snowboard binding or base plate can be individually positioned in this manner also transversely to the longitudinal direction of the snowboard.

The embodiment of the snowboard binding, in connection with which at least one oblong breakthrough is formed in each of the front and rear base plate components for passing through fastening screws for securing the two base plate components on a snowboard, permits each base plate component to pivot individually in relation to the snowboard, on the one hand, as well as individual alignment of the angular position of the entire snowboard binding vis-à-vis the snowboard on the other.

The embodiment of the snowboard binding, where the breakthroughs are circular with respect to the stand-on plane, pivoting of the base plate components around a defined axis is achieved, and interfering deviations of the base plate components in the radial direction relative to the pivotal axis are prevented from occurring.

Owing to the fact that the angle between the center axis of the front base plate component and the center axis of the rear base plate component can be adjusted and fixed within a maximum range of from 150° to 180°, preferably from 165° to 180°, the two base plate components can be relatively adjusted, starting from a stretched position to a curved position, whereby high stability of the base plate is achieved because adequately high dimensions of material thickness can be used in the transitional zone between the front base plate component and the rear base plate component.

The embodiment of the snowboard binding, in connection with which the angle between the center axis of the front base plate component and the center axis of the rear base plate component can be adjusted and fixed within a maximum range of from 150° to 210°, preferably from 165° to 195°, offers the advantage that viewed from the top, it is possible with only one base plate to adjust an alignment of the latter either cranked to the left or cranked to the right, so that the snowboard binding as defined by the invention can be adapted to both the shape of the left and the shape of the right snowboarding boot. At the same time, such a design permits an optimal alignment of the calf support, which in turn permits an ideal transmission of controlling or steering forces to the snowboard.

In the embodiment of the snowboard binding, in which at least one adjusting and locking device for activating and deactivating a clamping connection is provided between the front and the rear base plate components, an infinitely variable adjustment of the relative positions between the base plate components is made possible. In addition, a structurally simple adjusting and locking device is made available at the same time, which in turn permits the snowboard binding to be structured at favorable cost.

In the embodiment of the snowboard binding, where an adjusting and locking device is provided for activating and deactivating a positive connection between the front and the rear base plate components, whichever relative positions between the base plate components are deemed preferable can be fixed with high stability, and undesirable adjustment movements between the base plate components are safely suppressed even if force is introduced in the form of pulses.

Canting or oblique positions between the respective top sides or stand-on planes of the base plate components can be set because the pivotal axis of the rotational support is inclined versus the stand-on plane. The angle of force introduction or direction of transmission of the controlling forces can be additionally changed or adapted in this manner.

Due to the fact that at least one of the base plate components is provided with a wedge-like shape, the inclination of the calf support can be advantageously changed in a simple way by changing the positions of the two base plate components in relation to one another. In addition, it is possible to change the ratio of the support pressure of the snowboarding boot between the front and the rear base plate components.

A safe and stable connection is created between the two base plate components on account of the fact that at least one support plane between the front base plate component an the rear base plate components is inclined with respect to the stand-on plane for the snowboarding boot, which, in addition, permits the angle of inclination to be changed in a simple manner.

In the embodiment of the snowboard binding, in which a adjustably supported wedge element is arranged between the rear base plate component and the front base plate component for supporting the load, it is advantageous that the inclination of the calf support can be adjusted independently of its angular position, or irrespectively of the angular position of the rear base plate component. In particular, the inclination of the calf support can be maintained unchanged if the angular position of the calf support is changed around a vertical axis in accordance with the preferences of the snowboarder. Analogously, the inclination of the calf support can be changed via the adjustably supported wedge element without altering the angular position of the calf support.

The embodiment of the snowboard binding, in which the wedge element is supported in a linearly adjustable manner and its relative position can be individually changed by the snowboarder, it is beneficial that the angle of inclination of the calf support can be changed in a simple way as well.

The embodiment of the snowboard binding, where the wedge element is rotationally supported, pivoting around an axis extending substantially perpendicularly relative to the stand-on plane, permits quick changing of the angle of inclination of the calf support depending on the given angle of rotation of the wedge element relative to the rear base plate component.

Owing to the design of the snowboard binding, in connection with which the rear base plate component holds the calf support by means of at least one pivotal joint forming a pivotal axis extending transversely to the longitudinal axis of the binding and substantially parallel to the stand-on plane, the calf support is capable of assuming a position in which it is pivoted downwards, which is particularly space-saving when the binding is not in use.

Owing to the embodiment of the snowboard binding, in which the pivotal joint or base plate is forming a device for limiting the angle of rotation between the calf support and the rear base plate component in the rearward direction, the intensity or direction of the introduction of controlling forces into the snowboard can be additionally changed or adapted.

With the embodiment of the snowboard binding, in which the rear base plate component is forming or supporting a U- or bracket-shaped support element with respect to the stand-on plane, and said pivotal joint is holding the calf support within a limited range of rotation of the latter on an axis of rotation extending transversely to the longitudinal axis of the binding and substantially parallel to the stand-on plane, and/or at least the rear section of the U- or bracket-shaped support element is disposed behind the rear-most edge of the rear base plate component and above the stand-on plane, and/or the lower-most end section of the calf support is disposed behind the rear-most edge of the rear base plate component and at a distance above the stand-on plane, what is accomplished is that any premature contact with the surface of the snowboarding course is avoided even when the snowboard binding is in steeply slanted positions.

The assembly of the snowboard binding or of the base plate components is simplified in that face ends of the front base plate component and the rear base plate component facing each other are butt-jointed.

By virtue of the fact that at least one edge-shaped “clear” position or intermediate space is formed between face ends of the front and rear base plate components facing one another for the purpose of relative adjustability between the front and the rear base plate components, it is possible to ensure an adequate change in the orientation between the base plate components, or change in the alignment between the two base plate components.

The embodiment of the snowboard binding, in which ends of the front base plate component and ends of the rear base plate component overlapping one another are curved or provided with a semicircular shape, is advantageous as well in that the resulting transition between the two base plate components has as few gaps as possible between said components, with the latter being in any angular position in relation to each other.

An embodiment of the snowboard binding, in which the front base plate component and the rear base plate component overlap one another substantially without any steps, i.e. smoothly, and/or the suppressing disk adjoins the front and the rear base plate components substantially steplessly as well, forming a substantially ridgeless, smooth connection, is advantageous as well in that in this way, no annoying pressure points will act on the foot of the snowboarder as the snowboarding boot is supporting itself in a load-transmitting manner on the base plate.

A further development of the snowboard binding, in connection with which the suppressing disk is provided on its underside with at least one extension with a wedge-shaped cross section, such an extension extending circularly or in a circular arc-shaped form around a center point of the suppressing disk, is advantageous in that it permits a reliable incremental or infinitely variable adjustment of the alignment of the base plate components versus the central suppressing disk.

The embodiment of the snowboard binding, in connection with which at least one groove-like recess, the latter being positively engageable with the at least one wedge-shaped extension, is formed in the front base plate as well as also in the rear base plate component, permits changing the curvature of the base plate as well as also the overall length of the base plate in a simple manner.

The embodiment of the snowboard binding, in which the spacing between the front and the rear base plate components can be changed and fixed, is advantageous as well in that different sizes of snowboarding boots can be optimally supported or received in this way with only one type of base plate.

Furthermore, the embodiment of the snowboard binding, in connection with which the width of the overlap between the front and rear base plate components is variable, permits the overall length of the base plate to be easily changed in a simple way.

The embodiment of the snowboard binding, in which at least one breakthrough or passage for receiving a screw is formed in a section of the overlap between the front and the rear base plate components, whereby the diameter of the screw shaft is smaller than the dimension of the at least one breakthrough or passage extending in the direction of the longitudinal axis of the binding, permits a quick change in the overall length of the base plate, so that the latter can be optimally adapted to the length of the sole of the snowboarding boot, or to the width of the snowboard being used.

Owing to the embodiment of the snowboard binding, in which several positive connection means in the form of elevations or recesses are formed in a section of overlap between the front and the rear base plate components, such connection means corresponding and being selectively engageable with each other, and spaced from each other in the direction of the longitudinal axis of the binding, the total length of the base plate can be incrementally changed, whereby the adjusted total length is reliably fixed.

A safe and highly stable fixation of the adjustments selected for setting the total length of the base plate is assured by the embodiment of the snowboard binding in which the width of the overlap between the suppressing disk and at least one of the two base plate components can be changed and fixed as selected by the snowboarder by means of a plurality of positive connecting means in the form of extensions and recesses that correspond and are selectively engageable with each other.

However, especially advantageous is also the snowboard binding in connection with which a lateral limiting bridge, the latter being connected with and fixed on the front base plate component, and extending slidingly movably or relatively adjustably over the closest section of the rear base plate component, because any deviating or lift-off movements of the rear base plate component comprising the calf support, are counteracted in this way. In particular, the stability of the divided, multi-component base plate can be increased in this manner, and the thickness of the material of the base plate components can be selected relatively low without impairing the stability.

The embodiment of the snowboard binding, in which a lateral limiting bridge, which is connected with and fixed on the rear base plate component, is extending slidingly movably or relatively adjustably over the closest section of the front base plate component, is beneficial in that the front base plate component can be firmly pressed against the top side of the snowboard as the snowboard binding is being mounted on the latter.

Finally, the embodiment of the snowboard binding, in which limiting bridges arranged on opposite lateral edge sections of the front base plate component extend diverging from each other in the direction of the front base plate component, starting from the end section facing the rear base plate component, is advantageous in that the snowboarding boot can be received in this way in the snowboard binding with the least amount of play possible, because the heel part of the boot is comparatively narrower than the part of the boot disposed closest to the toes or balls of the toes. Moreover, in association with the changeability of the contour of the base plate, it is possible to achieve optimal adaptation to the snowboarding boot, so that the latter can be fixed in the snowboard binding free of play. Owing to such an arrangement with the least amount of play possible, the steerability of the snowboard equipped with the snowboard binding is increased because any delay in the transmission or transfer of force can be eliminated to the greatest possible extent.

### BRIEF DESCRIPTION OF THE DRAWINGS

The invention is explained in greater detail in the following with the help of the exemplified embodiments show in the drawings, in which:

FIG. 1 is a top view and simplified schematic representation of a snowboard binding with a base plate divided in its center section.

FIG. 2 is a sectional view of the snowboard binding according to FIG. 1 sectioned along the lines 11-11 in FIG. 1.

FIG. 3 is a simplified top view of another embodiment of the snowboard binding comprising base plate components adjustable relative to one another, whereby the calf support is again mounted on the rear base plate component.

FIG. 4 is a sectional view of the snowboard binding according to FIG. 3 sectioned according to the lines IV-IV in FIG. 3.

FIG. 5 is a top view and simplified schematic representation of another embodiment of the snowboard binding comprising a multi-component base plate.

FIG. 6 is a sectional view of the snowboard binding according to FIG. 5 sectioned according to the lines VI-VI in FIG. 5.

FIG. 7 is a top view and simplified schematic representation of a rearward part section of a snowboard binding with base plate components adjustable relative to one another.

FIG. 8 is a longitudinal section through the snowboard binding according to FIG. 1 sectioned according to line VIII-VIII in FIG. 7.

FIG. 9 is a longitudinal section and simplified representation by way of example of another form of embodiment of a multi-component base plate with a calf support arranged on the rear base plate component; and

FIG. 10 is a longitudinal section through and simplified schematic representation of a snowboard binding with a plurality of base plate components, in connection with which the alignment and orientation among the base plate components receiving the snowboarding boot can be changed.

### DETAILED DESCRIPTION OF PREFERRED EMBODIMENTS

It is noted here by way of introduction that in the different exemplified embodiments described herein, identical components are provided with identical reference numbers or identical component designations, whereby the disclosures contained throughout the present specification may be applied in the same sense to identical components with the same reference numbers or component designations. Furthermore, data relating to positions selected in the specification such as, e.g. “top”, “bottom”, “lateral” etc. relate to the figure directly described and shown, and have to be applied in the same sense to any new position where a position has changed. Moreover, individual features or combinations of features of the different exemplified embodiments shown and described herein per se may represent independent inventive solutions or solutions as defined by the invention.

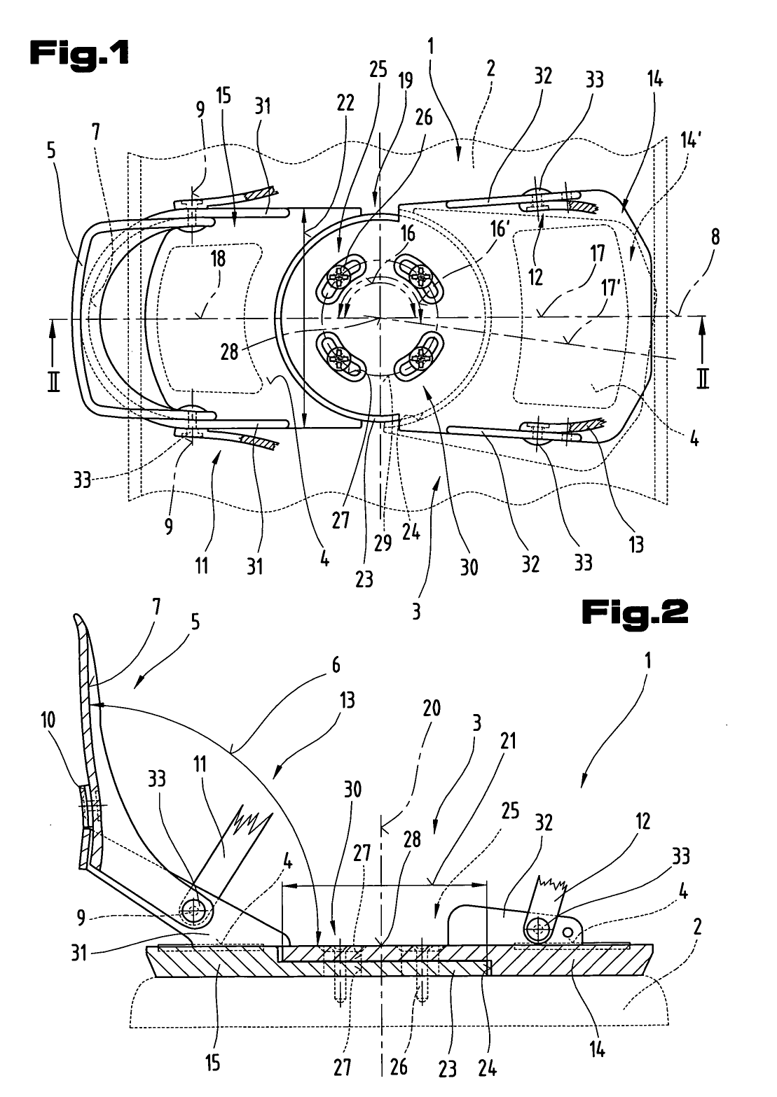

FIGS. 1 and 2 show a schematized representation of a snowboard binding for detachably connecting a snowboarding boot with a snowboard 2. The snowboard 2, which is shown only in part and simplified and known per se, is a board-like gliding device for surfing on snow, whereby the two feet of the snowboarder are supported via the snowboard binding 1 on the snowboard 2 associated with each foot. The snowboard bindings 1, which have to be mounted on the snowboard 2 in pairs, are usually aligned transversely to the longitudinal center axis of the snowboard 2 within a defined angular range, so that the snowboarder is standing with his or her two feet more or less firmly set up on the snowboard 2 crosswise to the longitudinal direction. The longitudinal axis of the snowboard binding 1 may be aligned approximately parallel to the longitudinal axis of the snowboard 2.

In the following description, terms such as “rearwards” or “rear” relate to the heel section or the area of the snowboard binding 1 disposed closest to the calf of the leg. On the other hand, terms such as “frontal” or “front” relate to the toes or sections of the snowboard binding 1 disposed closest to the balls of the toes.

When the snowboard is in use, the sole of the snowboarding boot, which is not shown for the sake of superior clarity, is supported on a substantially plane stand-on surface 4 of the base plate 3 of the snowboard binding 1 in a way transmitting the load or force. Said surface 4 may slightly ascend in the face-side end areas, if need be. The base plate 3 is conceived in this connection for safely mounting it on the snowboard 3 in such a way that it cannot be torn off. In particular, the base plate 3 is provided with such stability that forces such as, e.g. steering forces occurring between the foot of the snowboarder and the snowboard 2 are safely absorbed and transmitted. The supporting or statically relevant elements of the base plate 3 are therefore made of solid or rigid materials such as, e.g. hard plastic and/or light metal.

As known per se, the base plate 3 may also comprise on its top side, or as part of the stand-on plane 4 at least one slip-proof or soft-elastic support cushioning for the sole of the snowboarding boot, as indicated by broken lines. Such a support cushioning is connected with the top side of the base plate 3, for example by gluing or screwing it to the latter. If necessary, the at least one support cushioning is partly received or inserted in a corresponding deepening on the top side of the base plate 3, as it indicated by broken lines.

Furthermore, a calf support 5 is formed in connection with the snowboard binding 1 shown, said calf support being substantially aligned perpendicularly to the stand-on plane 4 for the snowboarding boot. Such a calf support 5, which is frequently referred to as a so-called “highback”, serves for supporting the lower part of the back of the leg of the snowboarder for efficiently transmitting controlling or steering forces between the foot of the snowboarder and the snowboard 2. In particular, the calf support 5 projects upwards from the rearward area of the base plate 3 like a pole or wall.

The maximum angle of gradient or inclination 6 between a substantially vertically aligned support surface 7 for the rear section of the boot of the snowboarder, and the substantially horizontally extending stand-on plane 4 on the base plate 3 is either prefixed or adaptable to the individual requirements of the snowboarder. For such adaptation, the calf support is pivot-mounted and capable of swiveling to a limited extent around at least one pivotal axle 9 extending substantially transversely to the longitudinal axis 8 of the binding, and substantially parallel to the stand-on plane 4. In practical applications, the maximum angle of inclination 6 of the calf support 5, which is limited by a stop element, amounts to about 110°. The maximum angle of inclination 6 between the stand-on surface 4 and the calf support 5 is usually individually fixable at a value in the range of 75° and 100°. For storing or transporting the snowboard binding 1 in a space-saving manner, it is possible also to pivot the calf support 5 in the direction of the base plate 3, or to fold it down, as it is known per se, so that the calf support 5 will then be substantially aligned parallel to the base plate 3.

For individually adjusting the maximum angle of inclination 6, provision may be made for a manually adjustable stop element 10 that determines the limitation of the maximum angle of inclination 6 of the calf support 5 in the rearward direction. The swiveling range of the calf support 5 in the rearward direction is limited in this connection depending on the position or alignment of said stop element 10. However, for limiting the maximum angle of inclination 6 for the calf support 5 it is possible also to employ other designs known from the prior art.

Furthermore, the snowboard binding 1 comprises at least one coupling element 11, 12, for detachably—if need be—connecting particularly a snowboarding boot with the snowboard binding 1 or its base plate 3. The at least one coupling element 11, 12 may be formed in this connection by at least one belt arrangement 13. Particularly a belt arrangement comprising a belt on the instep side and a belt on the toe side can be used in order to realize a safe and adequately play-free connection of the foot of the snowboarder with the snowboard 2. Alternatively to a belt-like coupling element 11, 12, or in combination with the belt arrangement 13, it is possible also to provide an automated coupling device in order to provide a connection between the snowboarding boot and the snowboard 2 that can be activated and deactivated as required and as comfortably as possible. In particular, the snowboard binding 1 may be a so-called belt binding or a so-called “step-in” binding.

So as to be able to better adapt the snowboard binding 1 to the physiological conditions or individual requirements of the snowboarder, the base plate 3 is designed to comprise at least two components, so that said base plate 3 is comprised of at least one front base plate component 14 and at least one rear base plate component 15. In particular, the base plate 3 is assembled from at least two base plate components 14 and 15, which are lined up one after the other, or from at least two of such base plate components that are at least partly arranged one on top of the other, and adjustable relative to each other as needed, whereby the size of the stand-on plane 4 and/or a defined contour of the base plate 3 is obtained or can be individually adjusted. Therefore, the base plate 3 of the snowboard binding 1 comprised of at least two components can be individually changed and fixed with respect to its stand-on surface area for the snowboarding boot and/or with respect to its contour.

The base plate 3 is consequently formed by at least the two base plate components 14 and 15, whereby the front and the rear base plate components 14 and 15, respectively, each form a support for the front and rear sections of the sole of the snowboarding boot.

In the embodiment shown, the base plate 3 is divided in its center section, whereby the front base plate component 14 and the rear base plate component 15 partly merge into one another. In particular, the front and rear base plate components 14 and 15, respectively, overlap each other in their end sections associated with each other.

The coupling element 12 or the front belt arrangement 13 is preferably mounted on the front base plate component 14, and the rear coupling element 11 or the rear belt arrangement 13 is preferably connected with the rear base plate component 15.

It is important that with the help of the two-component embodiment of the base plate 3 of the snowboard binding 1, the alignment and/or orientation between the front and rear base plate components 14 and 15, respectively, can be changed by the snowboarder preferred, and fixed in the desired relative position. In this connection, the calf support 5 is supported on the rear base plate component 15 and connected for moving jointly with the latter.

In particular, the base plate 3 comprising at least two components permits that at least the alignment or orientation between the front base plate component 14 and the rear base plate component 15 usefully can be changed to a limited extent by the user or dealer selling the snowboard binding 1. This permits easy adaptation to the individual needs or preferences of the snowboarder, and the performance achievable with the snowboard binding 1 or snowboard 2 can be optimized. On the other hand, the snowboarder's comfort in using this equipment can be raised owing to the individual adaptability of the base plate 3 to the shape of the boot or given boot dimensions or contours of the sole of the boot.

Adjustability of the orientation between the front and rear base plate component 14 and 15, respectively, means that the angle 16 between the center axis 17 of the front base plate component 14, and the enter axis 18 of the rear base plate component 15 can be changed as required or preferred. Based on the starting position shown by way of example in FIG. 1, where the angle 16 amounts to about 180°, said angle 16 can be reduced and/or increased by a certain amount as preferred. In particular, the angle 16 enclosed between the center axis 17 of the front base plate component 14 and the center axis 18 of the rear base plate component 15 can be adjusted and fixed within a maximum range of from 150° to 180°, usefully in the range of from 165° to 180°. In other words, based on the straight-line, stretched starting position shown in FIG. 1, such a design permits a change in the orientation between the two base plate components 14 and 15 in only one direction.

Alternatively, a bidirectional change in the angle 16 is possible as well, based on the long-stretched starting position shown by way of example. Therefore, with the preferred bidirectional variability of the angle 16, starting from a value of 180°, it is possible to adjust and fix that said angle 16 between the center axis 17 of the front base plate component 14 and the center axis 18 of the rear base plate component 15 within a maximum range of from 150° to 210°, usefully within a range of 165° and 195°. In other words, based on the long-stretched position, the angle 16 can be changed to at least one other enlarged or reduced position with an obtuse angle 16.

A relative position between the front base plate component 14 and the rear base plate component 15 is illustrated in FIG. 1 by way of example by the front base plate component 14′ shown by broken lines, with its center axis 17′, where the original angle 16 has been changed to an obtuse angle 16′ exceeding 180°. Likewise, it is possible to adjust the rear base plate component 15 vis-à-vis the front base plate component 14, or to adjust both base plate component 14 and 15 versus the snowboard 2 to any desired relative positions.

It is useful if a rotational support 19 is provided between the front base plate component 144 and the rear base plate component 15 as shown in FIGS. 1 and 2. Such a rotational support 19 forms a pivotal axis 20, which is aligned substantially perpendicularly to the stand-on plane 4 and connects the two base plate components 14, 15 rotationally. The rotational connection between the two base plate components 14, 15 is realized in this connection by the centrally positioned fastening means 25 in the form of the screws 26, among other elements, with such screws serving at the same time for securing the multi-component base plate 3 on the snowboard 2.

In the present schematized embodiment, the pivotal axis 20 of the rotational support 19 is extending between the front and rear base plate components 14 and 15, respectively, exactly perpendicularly to the stand-on plane 4 for the snowboarding boot, or exactly perpendicularly to the lower side of the base plate 3.

In the embodiment shown in FIGS. 1 and 2, the front base plate component 14 and the rear base plate component 15 overlap one another in their ends sections facing one another. In the present exemplified embodiment, the longitudinal expanse of such overlapping, or the overlap width 21 amounts to about one third of the overall length of the base plate 3 with respect to the longitudinal axis 8 of the binding. However, the overlap width 21 between the front and rear base plate components 14 and 15, respectively, may also be in a range of 25% and 50% of the overall length. Preferably, the overlap width 21 has a minimum percentage value of about 33% of the overall length of the base plate 3 in order to assure a stable and robust structure of the assembled multi-component base plate 3. It is advantageous if the overlap width 21 corresponds with about the width 22 of the assembled base plate 3 in its center section. In this way, the connection obtained between the front and rear base plate components 14 and 15, respectively, will be as solid and stable as possible.

Furthermore, it is useful if the ends of the first or front base plate component 14 and the second or rear base plate component 15 overlapping one another have a curved or about semicircular shape, as it is shown most clearly in the representation according to FIG. 1. In particular, viewed from the top, a substantially curved or semicircular extension 23 of the one base plate component 14 or 15 is extending into a corresponding, mating recess 24 of the other base plate component 14 or 15. The thickness of the extension 23 comes to about half of the thickness of the base plate 3.

Instead of using a single-tooth or leaf-like tooth connection, it is possible also to provide a multi-tooth system, whereby a multitude of the extensions 23 are formed on each base plate component 14, 15, which, in conjunction with corresponding indentations or slots results in a positive, flexible connection or overlap between the end sections of the base plate components 14 and 15 facing each other.

The at least one flattening on each of the ends of the base plate components 14 and 15 facing each other, results in this connection in a substantially stepless, smooth transition, so that a uniform base plate 3 is formed that appears to consist of only one single piece. Alternatively, it is possible also that the extension 23 of the one base plate component 14 or 15 engages a corresponding slot-like recess 24 in the other base plate component 15 or 14, forming the rotational support accordingly.

In its center section, i.e. where the base plate components 14 and 15 overlap one another, the base plate 3 can be joined with the snowboard 2 in a tear-off proof manner. For this purpose, at least one fastening means 25 is formed, via which the snowboard binding 1 or base plate 3 is connectable with the snowboard 2. Such a fastening means 25 is preferably formed by a screw 26. In the advantageous embodiment shown, a total of four screws 26 are provided for safely connecting the base plate 3 or two base plate components 14 and 15 with the snowboard 2 in a tear-off proof manner. However, it is possible also to provide for only two or three screws 26 for securing the snowboard binding 1 on the snowboard 2.

In the embodiment according to FIGS. 1 and 2, at least one oblong breakthrough 27 is formed in each of the front and rear base plate components 14 and 15, respectively. Said breakthrough is dimensioned for the passage of the screws 26 for securing said components on the snowboard 2. It is particularly useful in connection with a multiple-screw-and-breakthrough (26; 27) arrangement, and especially with a three-screw and-breakthrough (26; 27), or with the four-screw-and-breakthrough (26; 27) arrangement shown, if the breakthroughs 27 are provided with a semicircular shape with respect to the stand-on plane 4, particularly in the normal projection on said stand-on plane 4. The individual semicircularly shaped breakthroughs extend in this connection around a common center point 28 with a radial distance from the latter, said center point coinciding with the pivotal axis 20 or being disposed on said axis. In other words, the longitudinal center axes of the semicircular breakthroughs 27 are disposed in an imaginary circle 29, with the center point 28 or the pivotal axis 20 of the rotational support 20 being disposed in the center of said circle. The breakthroughs 27 are arranged distributed over the circumference of the circle 29. What is achieved in this way is that the screws 26 will form a stable rotational support 19 for the entire base plate 3 versus the snowboard 2, and it is ensured in this manner that each base plate component 14, 15 is rotatably supported vis-à-vis the snowboard 2. In particular, a stable rotational support 9 is provided that permits a relative rotational adjustment of the front base plate component 14 versus the rear base plate component 15, and vice versa. In other words, such a rotational support 19 permits changing the angular position of the base plate 3 or of the entire snowboard binding 1 versus the snowboard 2, and, in addition, permits changing the angle 16 between the front and rear base plate components 14 and 15, respectively.

The center points of the screws 26 are disposed in this connection in the corner points of an imaginary square, or in the corner points of an equally sided triangle. The spacing between the corner points of such a square or triangle amounts to approximately 4 cm. The width 22 of the base plate 3 in the center section comes to from 100 mm to 140 mm, so that the diameter of the semicircular extension 23 or semicircular recess 24 has a value in the range of from 100 mm to 140 mm as well. The circular arc-shaped circumference of the extension 23 or the peripheral edge of the circular arc-shaped recess 24 is preferably extending over more than 180°, e.g. over about 200°, so that the angle 16 between the front and rear base plate components 14 and 15, respectively, can be enlarged and also reduced.

Such an embodiment offers the special advantage that it is possible by means of the fastening means 25, or the screws 26 for securing the snowboard binding 1 of the snowboard 2, to create at the same time an adjusting and locking device 30 that permits an individual adjustment and fixation of the desired orientation or alignment of the base plate components 14 and 15, as well as also changing of the angular position of the base plate 3 or snowboard binding 1 vis-a-vis the longitudinal axis of the snowboard 2. Therefore, the adjusting and locking device 30 described above for the rotational support 19 permits changing and fixing the relative angular position between the base plate components 14 and 15, on the one hand, and also changing of the angular position of the entire base plate 3 or entire snowboard binding 1 relative to the longitudinal axis of the snowboard 2 on the other. Thus the rotational support 19 between the front base plate component 14 and the rear base plate component 15 is also a rotational support for the entire snowboard binding 1 or the entire base plate 3. The individual components or the total structure are pivoted in this connection around the common pivotal axis 20.

In the present embodiment, the adjusting and locking device 30 is formed by a structurally simple clamping connection between the overlapping sections of the base plate components 14 and 15, in conjunction with the top side of the snowboard 2, whereby said clamping connection can be activated or deactivated as needed. In particular, by loosening the respective screws 26 it is possible to easily change the relative positions of the base plate components 14 and 15 versus the snowboard 2, whereas by tightening the screws 26 or fastening means 25, the respective relative adjustability is cancelled. This assures safe and stable fixation of the desired relative positions versus the snowboard 2. For increasing the holding or clamping force of the clamping device or the locking force of the adjusting and locking device 30, it is possible also to make provision for means for increasing the friction between the respective surfaces abutting one another. Alternatively to or in combination with such a measure, it is possible also to make provision for positive connections or tooth systems for fixing the base plate components 14 and 15 vis-à-vis the top side of the snowboard 2, so that such fixation will safely withstand high forces. In other words, at least one adjusting and locking device 30 is formed that is designed for activating and deactivating a rigid connection between the front and rear base plate components 14 and 15, respectively. Such an adjusting and locking device 30 also permits the angular position of the entire snowboard binding 1 versus the snowboard 2 to be changed, particularly versus the longitudinal axis of the latter.

In order to achieve safe holding of the snowboarding boot on the base plate 3, the lateral limiting bridges 31 and 32 are formed preferably on the front and rear base plate components 14 and 15, respectively, said limiting bridges being arranged near the lateral edges of the base plate components 14 and 15. Said limiting bridges 31, 32, which are protruding substantially vertically from the stand-on plane 4, mainly prevent the snowboarding boot to slip off sideways versus the base plate 3. In addition, the limiting bridges 31, 32 opposing one another in the transverse direction relative to the longitudinal axis of the binding, are frequently used for securing the coupling elements 11, 12—particularly of the type of the belt arrangements 13—on the base plate 3 in a tear-off proof manner. For this purpose, provision is made for the screw-like or positively acting fastening means 33, which ensure particularly a rotationally movable and tear-off proof connection between the belt components of the belt arrangement 13 and the base plate 3, such a connection having limited mobility.

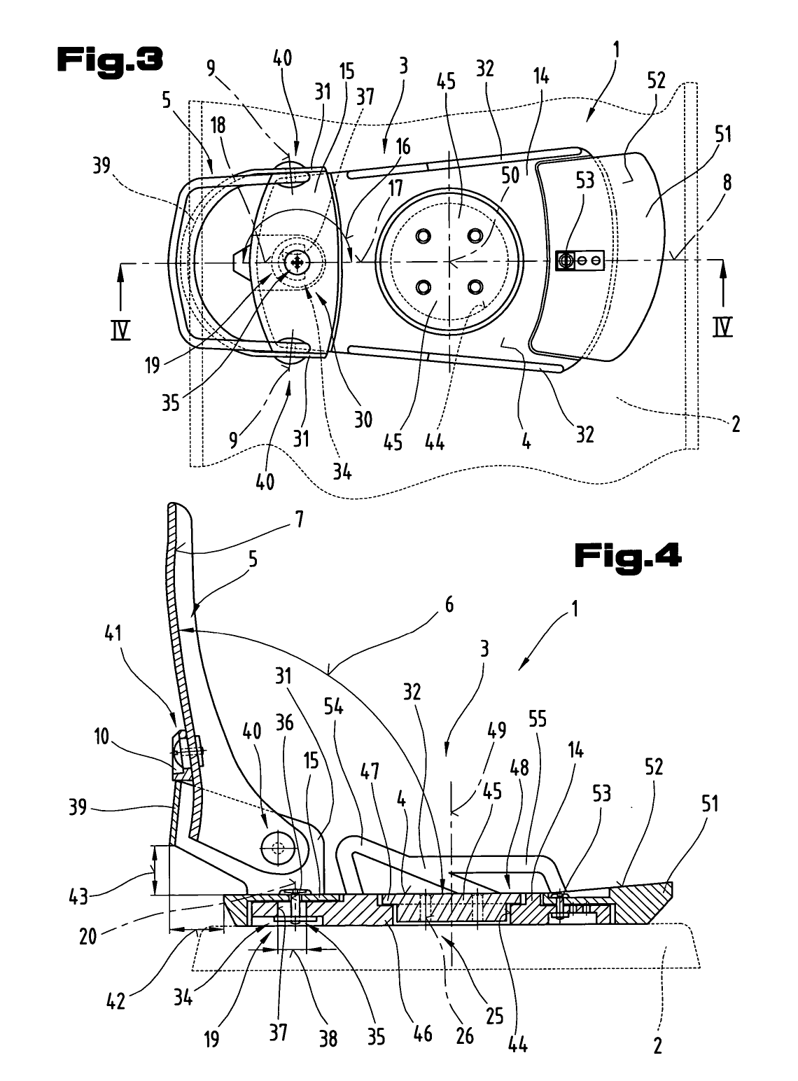

FIGS. 3 and 4 show another embodiment of the snowboard binding 1 with a multi-component base plate 3. The same reference numbers are again used for denoting components already described above, and the preceding parts of the description are applicable in the same sense to identical components denoted by the same reference numbers.

In the present embodiment, the front base plate component 14 is extending over a clearly longer longitudinal section of the base plate 3 than the comparatively shorter structured rear base plate component 15. In particular, the longitudinal expanse of the rear base plate component 15 amounts to about one fourth of the longitudinal expanse of the entire base plate 3 with respect to the longitudinal axis 8 of the binding.

The rear base plate component 15 again carries the calf support 5, i.e., the latter is mounted on said rear base plate component 15. The rear base plate component 15 and thus also the calf support 5 are changeable as needed within preset limits with respect to their orientation and alignment versus the front base plate component 14, and their desired adjustment is fixable, which is obvious if FIGS. 3 and 4 are viewed jointly.

In the present embodiment as well, the rear base plate component 15 rests at least partly on the front base plate component 14, which is shown best by the sectional representation according to FIG. 4. In particular, the rear base plate component 15 is supported at least by sections, e.g. with a major part of its underside on the top side of the end section of the front base plate component 14 facing it, in a manner transmitting the load. For changing the relative position between the rear base plate component 15 and the front base plate component 14 as required, at least one central adjusting and locking device 30—only one in the present case—is provided, which permits an individual adjustment and fixation of the desired relative position between the two base plate components 14 and 15 depending on the given operating conditions. In the present exemplified embodiment, said adjusting and locking device 30, which can be selectively activated and deactivated, is formed by a clamping device 34 comprising at least one corresponding screw-and-nut arrangement 35. In particular, with the clamping device 34 or the screw-and-nut arrangement 35 in the loosened condition, it is possible to change the alignment and orientation of the base plate component 15 including the calf support 5 vis-à-vis the base plate component 14 in accordance with the preferences of the snowboarder, and to subsequently immovably fix the desired relative positions between the two base plate components 14 and 15 by activating the clamping connection 34, particularly by tightening the screw-and-nut arrangement 35. The holding and fixing force of the clamping connection 34 is selected in this connection in such a way that the forces occurring during the use of the snowboard binding 1 are reliably withstood.

The screw-and-nut arrangement 35 penetrates the two base plate components 14, 15 in their flat sections overlapping or covering one another. At least one of the two breakthroughs 36, 37 in the base plate components 14, 15 for receiving the screw-and-nut arrangement 35 has a dimension greater than the largest diameter or cross section of the screw-and-nut arrangement 35 within said breakthroughs 36, 37. What is achieved in this way is that the rear base plate component 15 with the screw of the screw-and-nut arrangement 35 inserted therein, is relatively adjustable versus said comparatively large breakthrough 37, and the clamping connection 34 can be activated to assume the relative position desired between the base plate components 14 and 15. The limits of such relative adjustablity are determined in this connection by the size and form ratio between the at least one breakthrough 36, 37 and the connecting screw of the screw-and-nut arrangement 35.

The nut of the screw-and-nut arrangement 35 may be formed in this connection by a so-called flanged or cap nut for building up a stable and safe clamping connection 34. Alternatively, it is possible also to use shims or washers and the like in order to ensure safe clamping between the two base plate components 14 and 15.

The important feature is that the alignment and orientation of the rear base plate component 15, or of the calf support 5 coupled therewith, can be changed as required versus the front base plate component 14 owing to the formation of at least one breakthrough 37 that is enlarged with respect to the screw diameter. The enlarged breakthrough 37, which is preferably formed in the front base plate component 14, may have a semicircular, circular, crescent-like, rectangular or square shape, or it may be formed by a plurality of slots extending at an angle relative to one another. The breakthrough 37 in the front base plate component 14 is preferably covered by the rear base plate component 15 disposed on top of it, which is shown best in the sectional representation according to FIG. 4.

Therefore, the rear and front base plate component 15 and 14, respectively, overlap each other in the present embodiment as well, whereby the clamping connection 34, which can be activated and deactivated as required, is provided within said section of overlap, permitting fixation of the desired relative positions between the front and the rear base plate components 14 and 15, respectively.

The clamping connection 34 with the comparatively large breakthrough 37 for receiving the screw of the screw-and-nut arrangement 35 permits changing the alignment of the angle between the base plate components 14 and 15, on the one hand, and changing of the relative position between the two base plate components 14 and 15 in the direction of the longitudinal axis 8 of the binding, on the other. According to the embodiment shown, it is possible as well to change the relative position of the pivotal axis 20 for the rotational support 19 vis-à-vis at least one base plate component 14, 15, since the cross sectional dimensions of the breakthrough 37 are larger than those of the screw extending through the breakthrough 37.

Alignment between the base plate component 14 and 15 particularly is to be understood to mean a lateral offset between the center axes 17 and 18 of the front and rear base plate components 14 and 15, respectively, and/or a variation in the spacing between the two base plate components 14 and 15. It is particularly possible with the embodiment according to FIGS. 3 and 4 to change or to determine and fix both the angle 16 between the base plate components 14 and 15, and the lateral or longitudinal offset between the center axes 16 and 17, respectively.

Based on the starting position shown, any individual change in the lateral and/or longitudinal offset and/or orientation or alignment of the angle between the center axes 16 and 17 of the base plate components 14 and 15, respectively, is made possible in a simple manner for the snowboarder, lessor or seller of the snowboard binding 1 by means of the adjusting and locking device 30.

In the embodiment shown, the rear base plate component 15 is forming a U-shaped or bracket-like support element 39, the latter being mounted on the rear base plate component 15. Said support element 39 is U-shaped or has the contours of a bracket with respect to the stand-on plane 4. Said stable support element 39, which is capable of withstanding high support forces, holds or carries the calf support 5. In particular, the calf support 5 is flexibly connected with the support element 39 via the pivotal joint 40 forming the pivotal axle 40 already described above, whereby the swiveling movement of the calf support 5 is limited in the rearward direction by at least one stop means in the form of a device 41 limiting the angle of traverse. Said limiting device 41 comprises the stop element 10 already described above, which can be variably positioned and fixed in its vertical position versus the calf support 5. In particular, the maximum angle of inclination 6 of the calf support 5 is limited in that once a defined angle of inclination 6 has been reached, the stop element 10 comes to rest against the support element 39, particularly against its top edge, which prevents the calf support 5 from any further pivoting motion.

The rear section of the U-shaped or bracket-like support element 39 is preferably disposed at a distance 42 of 5 to 10 cm behind the rear-most edge of the rear base plate component 15. In addition, the rear section of the U- or bracket-shaped support element 39 is disposed above the stand-on plane 4. In particular, the lower-most end section of the calf support 5 or support element 39 is positioned at a distance 42 behind the rear-most edge of the rear base plate component 15, and at a distance 43 above the stand-on plane 4. What is achieved in this way is that it is possible with the snowboard binding 1 or snowboard 2 to assume relatively steep positions versus the ground, particularly vis-a-vis the surface of the snowboarding course, without parts of the snowboarding boot or snowboard binding 1 brushing against the surface of the course.

In the embodiment shown, a circular breakthrough 44 is formed in about the center area of the base plate 3, in which a corresponding circular suppressing disk 45 is inserted in order to solidly connect the base plate 3 or snowboard binding 1 with the snowboard 2 in different positions of the angle of rotation. The circular breakthrough 44 and the suppressing disk 45 have the corresponding extensions 46, 47, respectively, which assure that the suppressing disk 45 mounted on a snowboard 2 will solidly fix the associated base plate 3 on the snowboard, safely preventing it from lifting or tearing off. The suppressing disk 45 is mounted on the snowboard 2 via at least one fastening means 25, particularly by a plurality of the screws 26. The suppressing disk 45, with the at least one extension 47, extends over the at least one extension 46 in the peripheral area of the breakthrough 44. When the suppressing disk 45 is loosened versus the snowboard 2, rotation of the base plate 3 or snowboard binding 1 is made possible in the manner known per se in view of the longitudinal or transverse axis of the snowboard 2. In association with the circular breakthrough 44 in the base plate 3, the suppressing disk 45 thus forms a rotational support 48 for the base plate 3 or the snowboard binding 1. Said rotational support 48 defines an axis 49 extending perpendicularly to the top side of the snowboard 2. In the present embodiment, the rotational support 48 with the vertical axis 49 is spaced versus the pivotal axis 20 of the rotational support 19 between the front base plate component 14 and the rear base plate component 15 in the direction of the longitudinal axis 8 of the binding. In other words, this means that in the present embodiment, a substantially vertically extending pivotal axis is formed between the front and rear base plate components 14 and 15, respectively, and, in addition, a further axis 49 is separately formed, the latter being associated with the base plate 3 and the suppressing disk 47 on the one hand. On the other hand, in the embodiment according to FIGS. 1 and 2 described above, the pivotal axis 20 between the two base plate components 14, 15, and the axis for changing the angular position of the entire base plate 3 versus the snowboard 2 are formed by one common pivotal axis 20.

In the present embodiment according to FIGS. 3 and 4, the center point 50 of the suppressing disk 45 and of the breakthrough 44 is disposed in about the center of the base plate 3, or in the central area of the front base plate component 14, which is most clearly visible in FIG. 4. Said center point 50 is disposed on the axis 49, coinciding with said axis 49.

It is known per se that the base plate 3 may comprise a plate-like attachment part 51 in at least one end section on the face side. Such an attachment part 51, which is often referred to also as the “gas pedal” of the snowboard binding 1, has a slip-inhibiting surface and/or an inclined, ascending top side 52. In particular, said attachment part 51 may comprise the stand-on cushioning described above. The purpose of the friction-increasing surface or slanted, ascending top side 52 is to enhance the transmission of force between the snowboarding boot or its arched sole, and the snowboard binding 1 or snowboard 2. Such an attachment part 51, which is known per se and may be formed in the front end section or also in the rear end section of the base plate 3, may possibly also serve as an element for changing the length of the base plate 3, because it is optionally possible to connect the attachment part 51 with the base plate 3 in a number of possible positions distributed in the direction of the longitudinal axis 8 of the binding. It is possible in this way to adapt the snowboard binding 1 to different boot sizes with only one single type of base plate 3 comprising an attachment part 51 variably positioned in the longitudinal direction. Thus only one base plate 3 is required in order to accommodate different boot sizes. The immovable connection of the attachment part 51 with the base plate 3 in the set positions is realized with a screw 53 that can be anchored in one of several predefined screw holes, or in an oblong hole in the base plate 3. Said wedge-shaped, slippage-inhibiting attachment part 51, which is known per se, exclusively serves for telescopically changing the longitudinal expanse of the base plate 3.

The base plate 3 according to FIGS. 3 and 4 also comprises the lateral limitation bridges 31, 32 in order to achieve safe holding of the snowboarding boot on the base plate 3. The front limitation bridges 32 are formed in the present case not by plate-like elements, but by the framework- or frame-like profiles 54, 55. Said profiles 54, 55 forming the lateral limitation bridges 32 permit building up a particularly lightweight yet stable base plate 3. In addition, said profiles 54, 55 reinforce or stiffen the base plate 3 in its center area, where the relatively large breakthrough 44 for the suppressing disk 45 is formed. The profiles 54, 55 thus extend at least over a part area of the base plate 3 that is preferably dimensioned larger than the diameter of the suppressing disk 45 or breakthrough 44.

The rear limitation bridges 31 are formed in this connection by the legs of the U-shaped support element 39.

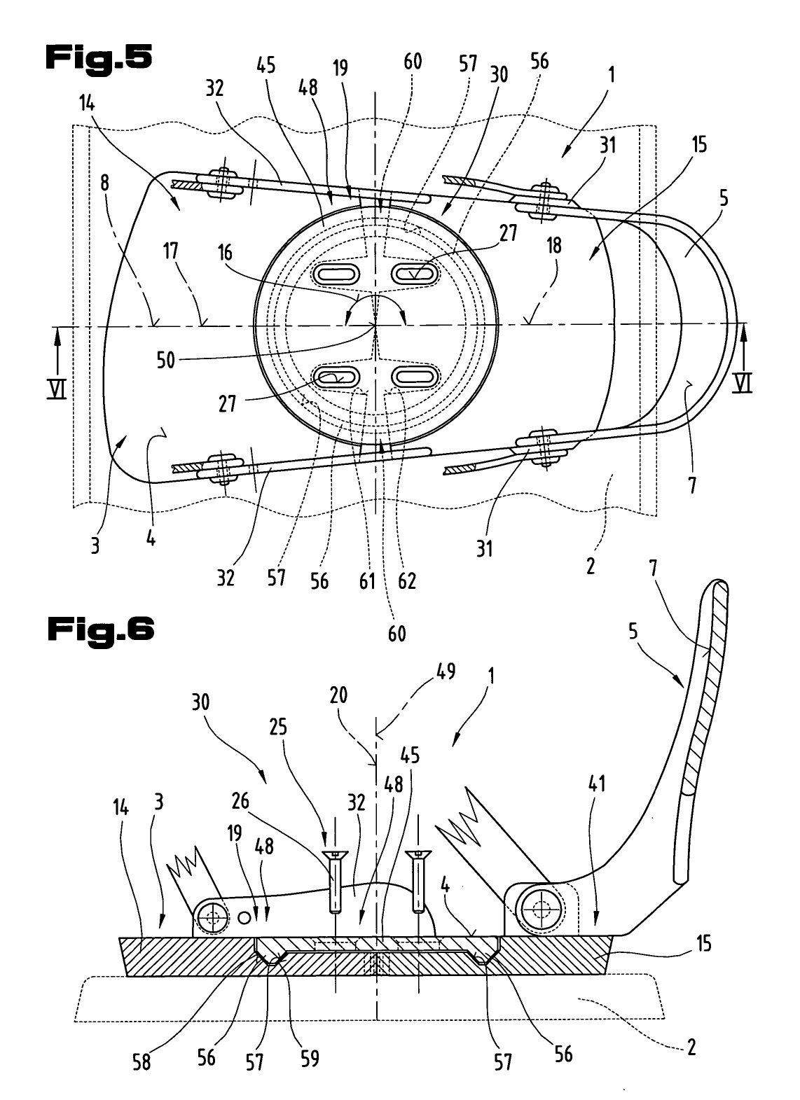

FIGS. 5 and 6 shows another embodiment of the snowboard binding 1. Again, the same reference number denote components identical to those already described above, and the preceding descriptions are applicable in the same sense to identical components denoted by the same reference numbers.

In the present embodiment, the base plate 3 is a two-component plate as well, whereby the plane of separation is positioned in about the longitudinal center of the base plate 3, said plane of separation extending substantially transversely to the longitudinal axis 8 of the binding.

The two base plate components 14 and 15 jointly forming the base plate 3 for safely supporting the snowboarding boot, are butt-jointed in line, i.e., in the present embodiment, the front and rear base plate components 14 and 15, respectively, do not overlap each other. In particular, the face ends of the front and rear base plate components 14 and 15, respectively, facing one another are disposed next to each other. In the present exemplified embodiment, the base plate components 14 and 15 abut each other substantially gap-free in a center point 50. Alternatively, however, it is possible also to form a through-extending gap between the base plate components 14 and 15, since the latter are kept in their respective nominal positions by means of the suppressing disk 45, as explained in detail below.

In the present embodiment of the snowboard binding 1, viewed from the top, the front base plate component 14 and the rear base plate component 15 are bridged by a circular suppressing disk 45, and said two base plate components 14 and 15 are connected and maintained in their nominal positions in that way. The suppressing disk 45 bridges only a part section of the two face ends of the front and rear base plate components 14 and 15 facing one another, as it is clearly visible in the representations according to FIGS. 5 and 6.

It is particularly advantageous if the suppressing disk 45 positively connects the front base plate component 14 with the rear base plate component 15, and at the same time forms the rotational support 19 between the front and rear base plate components 14 and 15, as well as also the rotational support 48 between the base plate 3 and the snowboard 2 assembled in this manner.

A possible positive connection between the suppressing disk 45 and the two base plate components 14 and 15, such connection forming at the same time the rotational supports 19 and 48, respectively, is shown in FIGS. 5 and 6. In particular, the suppressing disk 45 is provided on its bottom side with at least one extension 56, which preferably has a wedge-shaped cross section, as clearly shown in the sectional representation according to FIG. 6. Alternatively, said extension 56 may have the shape of a rectangle, trapeze, bridge, bead, semicircle, or it may be formed by a combination of straight lines and curves. It is important that on the bottom side of the suppressing disk 45, said at least one extension 56 enters into a form-locked or positive connection with the front and rear base plate components 14 and 15, respectively, and thus safely counteracts any deviating movement or separation movement between the base plate components 14 and 15 within the stand-on plane 4, while permitting, however, rotational movement when the suppressing disk 45 rests adequately loosely on the two base plate components 14 and 15.

The respective extension 56 on the bottom side of the suppressing disk 45 is preferably extending in the form of a circle or circular arc around the center point 50 of the circular suppressing disk 45. As an alternative, a circular arrangement of bar-like or pin-shaped extensions 56 on the bottom side of the suppressing disk 45 is possible as well. In the assembled state, said at least one extension 56 on the bottom side of the suppressing disk 45 engages at least one corresponding recess 57 in the two base plate components 14 and 15.

It is advantageous if the extension 56 has a wedge-shaped cross section, i.e. if it has the two slanted surfaces 58, 59 extending at an angle relative to one another, whereby the angle enclosed between said slanted surfaces 58, 59 amounts to between 30° and 150°, preferably to about 90°. The recess 57 in the two based plate components 14, 15 corresponding therewith is a groove-like deepening so as to produce a positive connection or rotational support 19 between the two base plate components 14, 15 via the suppressing disk 45, as best shown in FIG. 6.

Furthermore, it is useful if, with respect to the top side, the suppressing disk 45 substantially steplessly adjoins the front and rear base plate components 14 and 15, resulting in a substantially smooth transitional connection. In particular, the suppressing disk 45 is arranged sunk or deepened in the two base plate components 14 and 15 in order to form a stand-on plane 4 that is as plane-faced and smooth as possible. Especially any central elevation or center ascent in the base plate 3 is avoided due to the deepened arrangement of the suppressing disk 45.

The suppressing disk 45 may be formed by high-strength plastics, particularly from glass fiber-reinforced plastics, or from metal, particularly a light metal such as, e.g. aluminum. Low wall thickness values and small component dimensions are achievable particularly if the suppressing disk 56 is made of aluminum or a metal alloy, whereby high holding or clamping forces are nonetheless achievable for the two base plate components 14 and 15 via such a suppressing disk 45.

It is especially shown in FIG. 5 that at least one wedge-shaped clear space 60 or an intermediate space is formed between the face ends of the front base plate component 14 and the rear base plate component 15 facing each other. Such a clear or intermediate space permits the relative adjustability between the front and the rear base plate components 14 and 15, respectively. Said clear spaces 60, which, viewed from the top, are wedge-shaped, particularly permit the two base plate components 14 and 15 to pivot among one another. The opening angle of each wedge-shaped clear space may amount to, e.g. from 5° to 30°, preferably to about 15°. However, it is possible also to provide one single uninterrupted clear space 60 in order to assure adequate relative adjustablity or pivoting capability between the two base plate components 14 and 15.

Furthermore, it is clearly shown in FIG. 5 that the suppressing disk 45 substantially steplessly adjoins both the front and rear base plate components 14 and 15, respectively, forming a substantially stepless, positive connection between said base plate components 14 and 15. In the present embodiment, too, the adjusting and locking device 30 is formed by a central fastening means 25 or the four screws 26, which again are provided for activating and deactivating the nonpositive connection and positive engagement between the front and the rear base plate components 14 and 15, respectively. In particular, after the fastening means 25 for the suppressing disk 45 has been loosened, the orientation or alignment of the base plate components 14 and 15 can be changed. By simply tightening the screws or activating the fastening means 25, it is subsequently possible to fix the selected adjustment. Instead of using a fastening means 25 in the form of screws, it is naturally possible also to make provision for adjusting and locking devices that can be actuated without tools. In particular, a number of adjusting and locking devices 30 are known in the prior art that can be comfortably manipulated without tools for canceling or activating a clamping or positive connection between two or three elements.

It is shown, furthermore, that at least one oblong breakthrough 27 for a fastening means 25, particularly for a screw 26 is formed in the suppressing disk 45 for mounting it on a snowboard 2 in variable positions. It was found to be advantageous if the suppressing disk 45 has three or four of such breakthroughs 27 for mounting screws.

Both the front and rear base plate components 14 and 15, respectively, each comprise at least one recess 61, 62, respectively, disposed in the face ends facing one another. Said recesses 61 and 62 assure that each base plate component 14 and 15 is relatively movable versus the stationary fastening screws 26 anchored in the snowboard 2 after the fastening screws have been loosened, and the clamping force acting between the suppressing disk 45 and the base plate components 14 and 15 thus has been cancelled. The dimensions of the recesses 61 and 62 have to be selected larger than the diameter of the screws 26.

It is useful if a lateral limitation bridge connected fixed to the rear base plate component 15 is slidingly movably or relatively adjustably extending over a section of the front base plate component 14 disposed closest to it. In this way, the base plate components 14 and 15 are fixed in a stable and deviation-resistant manner. What is achieved in particular is that in the presence of high vertical forces acting on the front base plate component 14, the latter will remain in position on the snowboard 2 in a relatively stable and substantially unyielding way. Such an additional supporting or holding effect is achieved owing to the lateral limitation bridges 31 and 32 extending between the front and rear base plate components 14 and 15, respectively.

Alternatively or in combination with the above measures, it is possible also that a limiting bridge 32 connected with and fixed on the front base plate component 14, or molded onto said front component, forming one piece with the latter, is extending starting from the front base plate component 14 in the direction of the rear base plate component 15, and supported on the latter with sliding mobility, as shown in FIGS. 5 and 6. It is possible also in this way to more strongly and reliably counteract any movements of lift-off or deviation that may occur while the snowboard bonding 1 is being used. In particular, comparatively thin base plate components 14 and 15 can complement one another, forming a stable snowboard binding 1. Most of all, the relatively high forces introduced by the rear base plate component 15 into the calf support 5 thus can be reliably absorbed.

Furthermore, as shown most clearly in FIG. 5, it is useful if the two limiting bridges 32 arranged in opposite lateral edge sections of the front base plate component 14, extend diverging from each other, starting from the end section facing the rear base plate component 15 in the direction of the front end section, where the toes or balls of the foot of the snowboarder are positioned. It is assured in this way that the front base plate component 14 is adaptable in the best possible way to the natural form of the foot if its orientation or alignment is individually adapted to the shape of the snowboarding boot or sole of the latter.

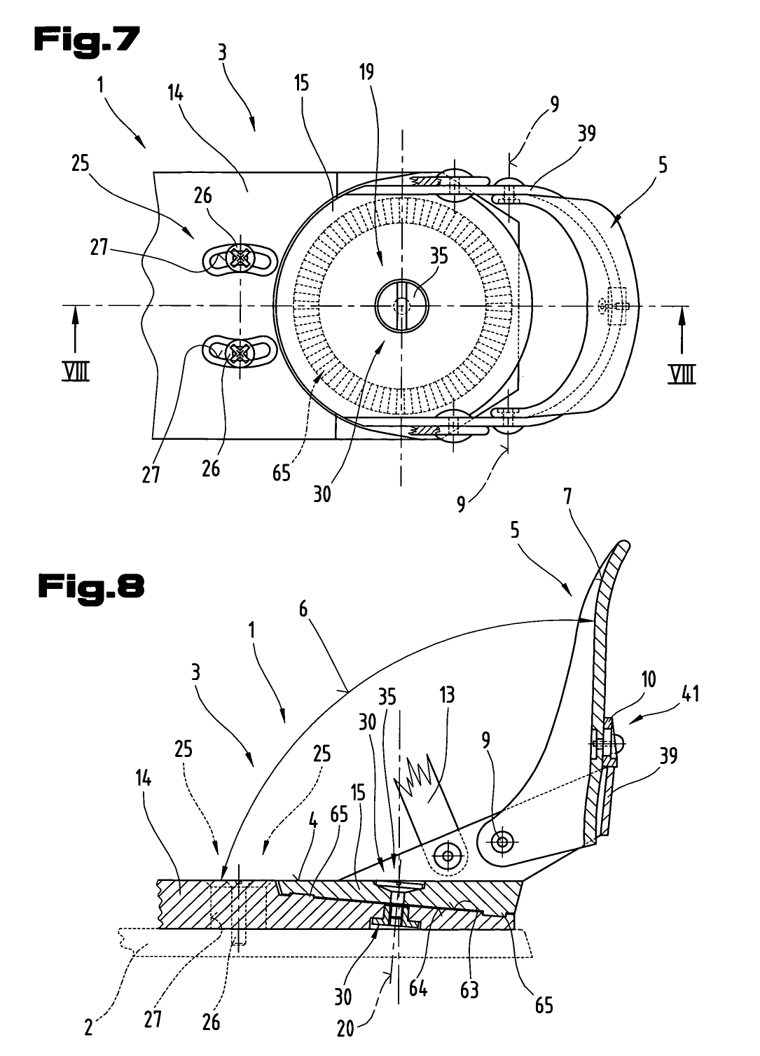

FIGS. 7 and 8 show yet another embodiment of the snowboard binding 1. The present representation only shows the rear section of the snowboard binding 1 with the calf support 5. Again, the same reference numbers are used for components and parts already described above, and the preceding descriptions are applicable in the same sense to identical components denoted by the same reference numbers.

The embodiment according to FIGS. 7 and 8 substantially corresponds with the one according to FIGS. 3 and 4 in that the rear base plate component 15 in supported there in a load-transmitting manner on the front base plate component 15 as well. In particular, the rear base plate component 15 is secured on the front base plate component 14 and rotationally adjustable versus the latter as needed. Particularly the rotational support 19 is formed again there as well, permitting the rear base plate component 15 or the calf support 5 supported thereon to pivot relative to the front base part component 14. The front base plate component 14 is connectable with the snowboard 2 via at least one fastening means 25. The latter is preferably formed by at least two screws 26 penetrating the front base plate component 14 through the circular arc-shaped breakthrough 27, fixing the base plate component 14 on the top side of the snowboard 2. The length of the curved, long-stretching breakthroughs 7 determines in this connection the capability of the front base plate component 14 and thus of the snowboard binding 1 of pivoting versus the snowboard.

The connection or coupling between the rear and front base plate components 15 and 14, respectively, is formed in this conjunction by a bolt or screw connection forming also the pivotal axis 20 of the rotational support 19.

It is important in this connection that the pivotal axis 20 of the rotational support 19 is extending inclined versus the stand-on plane 4 of the rear base plate component 15, or vis-à-vis the stand-on plane 4 of the entire base plate 3. Furthermore, at least one of the two base plate components 14, 15 is wedge-shaped. In the present exemplified embodiment, both base plate components 14 and 15 are wedge-shaped in at least part sections, as shown most clearly in FIG. 8. The latter shows, furthermore, that at least one support plane 63, 64 is extending slanted between the front and rear base plate components 14 and 15, respectively, with respect to the stand-on plane 4 on the top side of the base plate 3. The present representations clearly show that such a design permits a simple change in the angle of inclination 6 of the calf support 5 by rotating the rear base plate component 15 in relation to the front base plate component 14. In particular, so-called “canting” is provided for between the rear and the front base plate components 15 and 14, respectively. Such canting may permit enhanced or a more direct transmission of force between the boot of the snowboarder and the calf support 5.

It is advantageous if the connecting means, particularly the screw-and-nut arrangement 35 between the rear and front base plate components 15 and 14, respectively, is aligned inclined in relation to the stand-on plane 4. It is particularly beneficial if the axis of the screw-and-nut arrangement 35, which coincides with the pivotal axis 20, is extending perpendicularly to the support plane 63, 64. A simple connection can be realized in this manner between the base plate components 14 and 15 without having to make provision for complex shapes. Particularly the use of spherical segment-shaped screw heads and ball sockets for receiving the screw head is avoided by such measures.

The screw-and-nut arrangement 35 represents in this connection also the adjusting and locking device 30 which, through application of clamping forces, ensures safe fixing of the adjusted position of the angle of rotation of the calf support 5 or the rear base plate component 15.

It is advantageous if provision is made in the either horizontal or inclined support plane 63 and/or 64 between the base plate components 14 and 15, for a means increasing the friction, and/or for a tooth system 65 for safely fixing the adjusted positions of the angle of rotation. In particular, by providing for means for increasing the friction, or a tooth system 65 between the support surfaces or the support planes 63, 64, it is possible to create a coupling between the base plate components 14 and 15 that is secured against rotation to a high degree when the adjusting and locking device 30, the latter being formed by the screw-and-nut arrangement 35 or a lever arrangement, is activated or screwed tight with adequate torque.

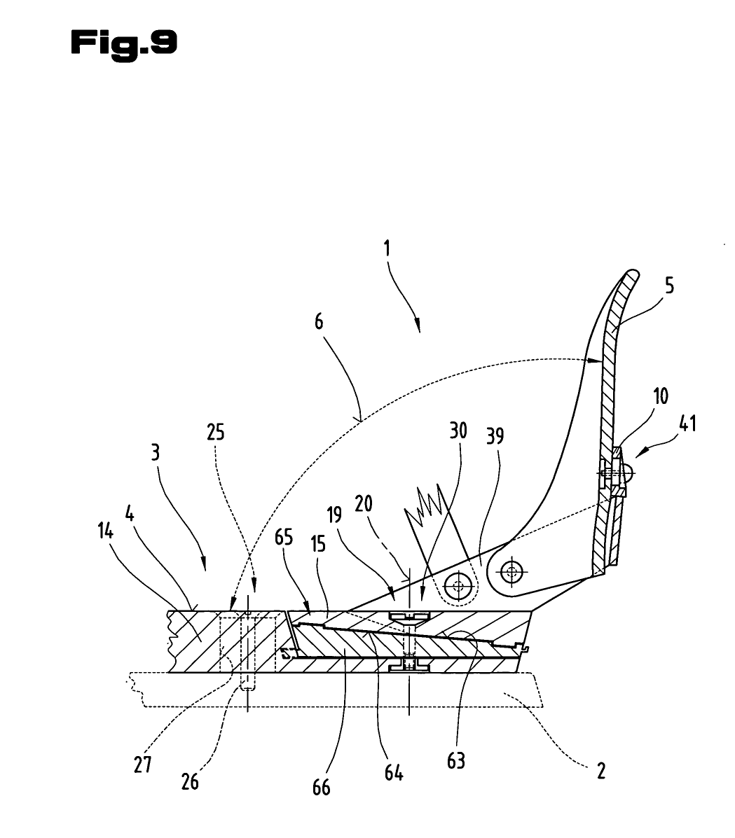

FIG. 9 shows a further development of the embodiment according to FIG. 8, where particularly an adjustably supported wedge element 66 is formed. Said wedge element 66 is arranged between the rear base plate component 15 and the front base plate component 14 for supporting and transmitting the load. Such a wedge element 66 may be designed for linear adjustability, whereby its relative position can be individually adjusted by the snowboarder. The slanted position or inclination of the rear base plate component 15 versus the front base plate component 14 can be individually adjusted in this way. It is possible at the same time to adjust the angle of inclination 6 of the calf support 5 ass well.

According to the embodiment shown in FIG. 9, however, the wedge element 66 can be pivoted also around an axis substantially extending perpendicularly to the stand-on plane 4 so as to be able to adjust different angles of inclination of the vertical axis of the calf support 5. Said wedge element 66 is designed in a way such that in the starting or idle position according to FIG. 9, the bottom side of the wedge element 66 and the top side of the rear base plate component 15 extend substantially parallel to one another. When the angular position of the wedge element 66 is changed, starting from the starting position shown, the inclination of the rear base plate component 15 versus the stand-on plane 4, or vis-à-vis the top side of the front base plate component 14 is changed as well. It is particularly advantageous in this connection that it is possible to change the position of the angle of rotation of the calf support 5 without necessarily having to change the angle of inclination 6 of said calf support 5. The recess for receiving the screw head is preferably realized in the form of a ball socket.

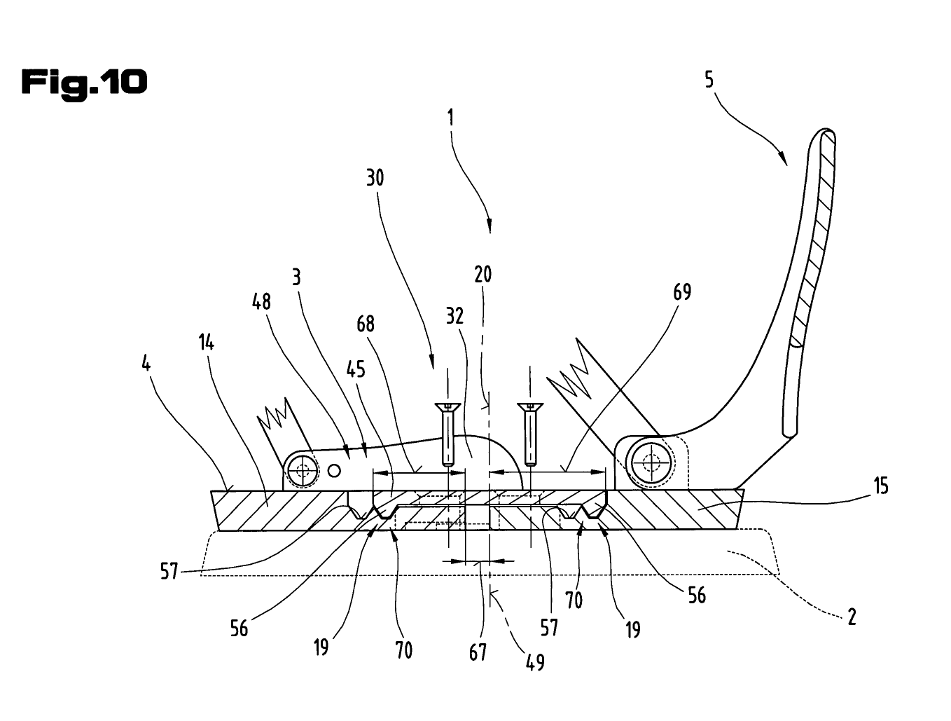

FIG. 10 shows yet another embodiment of a snowboard binding 1, in which the spacing 67 between the front and rear base plate components 14 and 15, respectively, is individually changeable for adapting the overall length of the base plate 3 to individual requirements or preferred adjustments. Therefore, not the width of the overlap between the base plate components 14 and 15 is changed in this connection, as it is the case in connection with the embodiments according to FIGS. 1, 2, 3 and 4, but rather the spacing 67 between the base plate components 14 and 15 is altered.

In particular, the overlap width 68, 69 between the suppressing disk 45 and at least one the base plate components 14, 15 can be changed and fixed by the snowboarder as needed by means of the positive connection means 70 in the form of the extensions 56 and recesses 57, said means corresponding with each other and being selectively engageable.

It can be understood best in association with FIG. 9 that several corresponding and selectively engageable, positive connection means in the form of elevations and deepenings may be formed also in a section of overlap between the front and rear base plate components 14 and 15, respectively, in order to achieve an incremental or stepped adjustment between the base plate components 14 and 15 in the direction of the longitudinal axis 8 of the binding. In this conjunction, the corresponding elevations and deepenings provided in the section of overlap between the base plate components 14 and 15 are spaced from each other in the direction of the longitudinal axis of the binding.

For increasing the stability and cohesion between the two base plate components 14 and 15, it may be useful if the rear base plate component 15 extends under the front base plate component 14, as indicated in FIGS. 10 and 9 by broken lines. Any tilting movement of the rear base plate component 15 is effectively counteracted in this way, since the front base plate component 14 is capable of effectively counteracting any tilting or lifting movement of the end section of the rear base plate component 15 facing it.

For increasing the stability of the base plate 3 assembled from the base plate components 14 and 15, it is possible also to connect the base plate components 14 and 15 and/or the lateral limitation bridges 31 and 32, respectively, with each other in the manner of a telescope or hinge. Such a telescopic or hinged connection permits changing the orientation and/or alignment between the base plate components 14 and 15 with increased overall stability as well.

The exemplified embodiments show possible design variations of the snowboard binding 1, whereby it is noted that the invention is not limited to the specific design variations shown herein, but that also various combinations of the individual design variations among one another are possible, and that in light of the instruction for technical execution provided by the present invention, such variability falls within the scope of the skills of the expert engaged in the present technical field. Therefore, all conceivable design variations feasible by combining individual details of the embodiment variations shown and described herein, are jointly covered by the scope of protection as well.

It is finally pointed out for the sake of good order that in the interest of superior understanding of the structure of the snowboard binding 1, the latter and its components are partly represented untrue to scale and/or enlarged and/or reduced.

The problems underlying the independent invention solutions can be deduced from the description.

Above all, the individual embodiments shown in the FIGS. 1, 2; 3, 4; 5, 6; 7, 8; 9; 10 may constitute the object of independent solutions as defined by the invention. The respective problems and solutions as defined by the invention are specified in the detailed descriptions of said figures.

List of Reference Numbers

| | |
|---|---|
| 1 | Snowboard binding |
| 2 | Snowboard |
| 3 | Base plate |
| 4 | Stand-on plane/surface |
| 5 | Calf support |
| 6 | Angle of inclination |
| 7 | Support surface |
| 8 | Longitudinal axis of binding |
| 9 | Pivotal axis |
| 10 | Stop element |
| 11 | Coupling element |
| 12 | Coupling element |
| 13 | Belt arrangement |
| 14 | Front base plate component |
| 15 | Rear base plate component |
| 16 | Angle |
| 17 | Center axis |
| 18 | Center axis |
| 19 | Rotational support |
| 20 | Pivotal axis |
| 21 | Overlapping area |
| 22 | Width |
| 23 | Extension |
| 24 | Recess |
| 25 | Fastening means |
| 26 | Screw |
| 27 | Breakthrough |
| 28 | Center point |
| 29 | Circle |
| 30 | Adjusting and locking device |
| 31 | Limitation bridge |
| 32 | Limitation bridge |
| 33 | Fastening means |
| 34 | Clamping connection |
| 35 | Screw-and-nut arrangement |
| 36 | Breakthrough |
| 37 | Breakthrough |
| 38 | Dimension |
| 39 | Support element |
| 40 | Pivotal joint |
| 41 | Device limiting the angle of rotation |
| 42 | Distance or spacing |
| 43 | Distance or spacing |
| 44 | Breakthrough |
| 45 | Suppressing disk |
| 46 | Extension |
| 47 | Extension |
| 48 | Rotational support |
| 49 | Axis |
| 50 | Center point |
| 51 | Attachment part |
| 52 | Top side |
| 53 | Screw |
| 54 | Profile |
| 55 | Profile |
| 56 | Extension |
| 57 | Deepening |
| 58 | Inclined surface |
| 59 | Inclined surface |
| 60 | Clear space |
| 61 | Recess |
| 62 | Recess |
| 63 | Support plane |
| 64 | Support plane |
| 65 | Tooth system |
| 66 | Wedge element |
| 67 | Spacing |
| 68 | Overlap width |
| 69 | Overlap width |
| 70 | Connecting means |

What is claimed is:

1. A snowboard binding with a stable base plate made of solid or rigid materials and intended for mounting on a snowboard, with a stand-on plane being formed on the top side of said base plate for supporting the sole of a snowboarding boot; with a calf support aligned substantially perpendicularly to the stand-on plane of the base plate for supporting the lower back part of the leg of the user, and with at least one coupling element for detachably, if need be, connecting the snowboarding boot with the base plate, wherein the base plate is formed by at least two base plate components, whereby the front and the rear base plate components each form a support for the front and rear sections of the sole of the snowboarding boot; and the alignment and/or orientation between the front and rear base plate components are changeable and fixable by the user as needed, whereby the calf support is mounted on the rear base plate component.

2. The snowboard binding according to claim 1, wherein a rotational support is provided between the front and rear base plate components, said rotational support forming a pivotal axis aligned substantially perpendicularly to the stand-on plane.

3. The snowboard binding according to claim 2, wherein the pivotal axle of the rotational support can be variably positioned and fixed within the stand-on plane to a limited extent (FIGS. 3, 4).

4. The snowboard binding according to claim 2, wherein provision is made for one single central adjusting and locking device for the rotational support (FIGS. 3, 4).

5. The snowboard binding according to claim 1, wherein the front and rear base plate components overlap each other in their end sections facing each other (FIGS. 1,2).

6. The snowboard binding according to claim 1, wherein the rear base plate component is supported in a load-transmitting manner on the front base plate component (FIGS. 3, 4; 7, 8).

7. The snowboard binding according to claim 1, wherein provision is made for a circular suppressing disk plate bridging the front and rear base plate components (FIGS. 5, 6).

8. The snowboard binding according to claim 7, wherein the suppressing disk positively joins the front base plate component with the rear base plate component and forms the rotational support (FIGS. 5, 6).

9. The snowboard binding according to claim 7, wherein at least one oblong breakthrough is formed in the suppressing disk for a fastening means for mounting the latter on a snowboard in variable positions (FIGS. 5, 6).

10. The snowboard binding according to claim 1, wherein at least one oblong breakthrough is formed in each of the front and rear base plate components for receiving screws for securing the two base plate components on a snowboard (FIGS. 1, 2).

11. The snowboard binding according to claim 10, wherein the breakthroughs are circular arc-shaped with respect to the stand-on plane.

12. The snowboard binding according to claim 1, wherein the angle between the center axis of the front base plate component and the center axis of the rear base plate component is adjustable and fixable in a maximum range of from 150° to 180°, preferably from 165° to 180°.

13. The snowboard binding according to claim 1, wherein the angle between the center axis of the first base plate component and the center axis of the rear base plate component is adjustable and fixable in a maximum range of from 150° to 210°, preferably from 165° to 195°.

14. The snowboard binding according to claim 1, wherein at least one adjusting and locking device for activating and deactivating a clamping device is formed between the front and rear base plate components.

15. The snowboard binding according to claim 1, wherein an adjusting and locking device for activating and deactivating a positive connection is formed between the front and rear base plate components.

16. The snowboard binding according to claim 2, wherein the pivotal axis of the rotational support extends inclined versus the stand-on plane (FIGS. 7, 8).

17. The snowboard binding according to claim 1, wherein at least one of the base plate components has the shape of a wedge (FIGS. 7 to 9).

18. The snowboard binding according to claim 1, wherein at least one support plane between the front and rear base plate components is aligned inclined with respect to the stand-on plane for the snowboarding boot (FIGS. 7 to 9).

19. The snowboard binding according to claim 1, wherein an adjustably supported wedge element is arranged between the rear and the front base plate components, said wedge element supporting the load (FIGS. 7 to 9).

20. The snowboard binding according to claim 19, wherein the wedge element is linearly adjustably supported and its relative position is individually changeable by the snowboarder.

21. The snowboard binding according to claim 19, wherein the wedge element is rotationally supported for pivoting around an axis extending substantially perpendicularly to the stand-on plane (FIG. 9).

22. The snowboard binding according to claim 1, wherein the rear base plate component holds the calf support by means of at least one pivotal joint forming a pivotal axis extending transversely to the longitudinal axis of the binding and substantially parallel to the stand-on plane.

23. The snowboard binding according to claim 22, wherein the pivotal joint or the base plate forms a device for limiting the angle of rotation between the calf support and the rear base plate component in the rearward direction.

24. The snowboard binding according to claim 1, wherein the rear base plate component forms and supports a U-shaped or bracket-like support element with respect to the stand-on plane, and said support element supports the calf support with limited rotatability around a pivotal axis extending transversely to the longitudinal axis of the binding and substantially parallel to the stand-on plane.

25. The snowboard binding according to claim 24, wherein at least the rear section of the U-shaped or bracket-like support element is disposed behind the rear-most edge of the rear base plate component and above the stand-on plane.

26. The snowboard binding according to claim 1, wherein the lower-most end section of the calf support is disposed behind the rear-most edge of the rear base plate component, and at a distance above the stand-on plane (FIGS. 3, 4).

27. The snowboard binding according to claim 1, wherein the face ends of the front and rear base plate components facing each other are butt-jointed (FIGS. 5, 6).

28. The snowboard binding according to claim 1, wherein at least one wedge-shaped clear space or intermediate space is formed between face ends of the front and rear base plate components facing each other for the relative adjustabilty between the front and rear base plate components (FIGS. 5, 6).

29. The snowboard binding according to claim 1, wherein ends of the front and rear base plate components overlapping one another are curved or circular arc-shaped (FIGS. 1, 2).

30. The snowboard binding according to claim 1, wherein the front and rear-base plate components substantially steplessly overlap one another (FIGS. 1, 2).

31. The snowboard binding according to claim 7, wherein the suppressing disk substantially steplessly adjoins the front base plate component, forming a substantially stepless connection.

32. The snowboard binding according to claim 7, wherein on its bottom side, the suppressing disk has at least one extension with a wedge-shaped cross section, said extension extending in the form of a circle or circular arc around the center point of the suppressing disk (FIGS. 5, 6).

33. The snowboard binding according to claim 32, wherein provision is made in each of the front base plate and rear base plate components for at least one groove-shaped deepening, the latter being positively engageable with at least one wedge-shaped extension (FIGS. 5, 6).

34. The snowboard binding according to claim 1, wherein a spacing is fixable between the front and the rear base plate components.

35. The snowboard binding according to claim 1, wherein the width of the overlap between the front and the rear base plate components is variable (FIGS. 3, 4).

36. The snowboard binding according to claim 1, wherein at least one break-through for receiving a screw is provided in a section of overlapping between the front and the rear base plate components, whereby the diameter of the screw shaft is smaller than the dimension of at least one breakthrough extending in the direction of the longitudinal axis of the binding (FIGS. 3, 4).

37. The snowboard binding according to claim 1, wherein a plurality of positive connecting means in the form of elevations and recesses are formed in a section of overlapping between the front and the rear base plate components, said connecting means corresponding with each other and being selectively engageable and spaced from one another in the direction of the longitudinal axis of the binding.

38. The snowboard binding according to claim 1, wherein the width of the overlapping between the suppressing disk and at least one of the two base plate components is variable and fixable by the snowboarder as needed by means of a plurality of positive connecting means in the form of extensions and recesses, said connecting means corresponding with one another and being selectively engageable (FIG. 10).

39. The snowboard binding according to claim 1, wherein a lateral limiting bridge connected fixed with the rear base plate component is extending with sliding mobility or relative adjustablity over a section of the front base plate component disposed closest to the rear base plate component (FIGS. 5, 6).

40. The snowboard binding according to claim 1, wherein a limiting bridge connected fixed with the rear base plate component is extending with sliding mobility or relative adjustability over a section of the front base plate component disposed closest to the rear base plate component.

41. The snowboard binding according to claim 1, wherein limiting bridges arranged opposite each other in lateral marginal sections of the front base plate component, extend diverging from one another, starting from the end section facing the rear base plate component in the direction of the front end section (FIGS. 5, 6).
